(19) United States
(12) Patent Application Publication
(10) Pub. No.: US 2012/0256783 A1
(43) Pub. Date: Oct. 11, 2012

(54) RADAR DETECTION AND LOCATION OF RADIO FREQUENCY (RF) DEVICES

(76) Inventors: Daniel L. Sego, Shoreline, WA (US); David Whelan, Newport Coast, CA (US); Robert Smith, Hampton Cove, AL (US)

(21) Appl. No.: 11/770,795

(22) Filed: Jun. 29, 2007

(51) Int. Cl. G01S 13/06; G01S 13/00

(52) U.S. Cl. 342/146; 342/193

(57) ABSTRACT

A system and method for detecting the presence of an RF device and determining a location of the RF device. The system includes a first antenna capable of transmitting a first radar signal and receiving RF signals, a second antenna capable of transmitting a second radar signal and receiving RF signals, where the second radar signal is offset in frequency from the first radar signal, and one or more processors. The one or more processors analyzes harmonic and intermodulation (IM) signals generated in response to the first radar signal and the second radar signal interacting with nonlinear characteristics in components of a RF device. The analyzing provides detection of the presence of the RF device and the determination of a location of the RF device regardless of whether the RF device is active or passive.

### BACKGROUND

Improvised Explosive Devices (IEDs) have been the cause of many fatalities to our armed forces. IEDs are roadside bombs that are remotely triggered when a vehicle, convoy or infantry formation passes near the device. Triggering is frequently accomplished using radio frequency means such as, for example, a cell phone that is called to detonate the device, a garage opener, or similar radio frequency (RF) component. These components are usually commercially available and are easily modified to serve as the remote trigger for the IED. These devices operate in portions of the RF spectrum that are allocated to commercial applications such as the Industrial, Security and Medical (ISM) bands.

The IED is usually a small package with a low visual signature that may be camouflaged (i.e., constructed to resemble something else, like a rock or brick), hidden by being covered with debris or garbage (easily accomplished in large portions of current urban operating theaters today), or buried. The IED environment is very dynamic with populations in movement, including non-combatants engaged in everyday activities. The IED generally consists of an explosive portion (warhead) with fusing and a remote trigger. The IED devices are usually created in a non-production method by amateurs using simple instructions, components and tools, and not in factories.

Current techniques to counter IEDs have included RF jammers and remote sensing techniques using radar or electro-optics. An RF jammer typically radiates a broad-band, noise-like signal in the operating band of the RF device, raising the noise floor in the device receiver in such a manner as to prevent the triggering signal or transmitted code from being detected. Thus the “phone call” doesn't connect, the command to activate is not received, and the IED device does not detonate. However, RF jammers are problematic in that they can potentially mask or interfere with many signals of interest, including critical communications for command and control. This may be particularly relevant in environments where the police and/or military forces may use dissimilar radio frequencies and protocols. Various remote sensing techniques have been used to locate some IEDs where the device is deployed on a surface, camouflaged, and/or buried. However, these techniques may be of limited use in an urban environment. Therefore, there remains a need in the art to remotely detect an IED that overcomes these and other deficiencies.

### SUMMARY

One or more embodiments of the present invention are related to a system for detecting the presence of an RF device and determining a location of the RF device. One embodiment includes a first antenna capable of transmitting a spectrally pure first radar signal and receiving RF signals, a second antenna capable of transmitting a second spectrally pure radar signal and receiving RF signals, where the second radar signal is offset in frequency from the first radar signal, and one or more processors. The one or more processor analyzes harmonic or intermodulation (IM) signals in varying patterns generated by an RF device in response to the first radar signal and/or the second radar signal interacting with nonlinear characteristics in components of the RF device. The analyzing provides detection of the presence of the RF device and the determination of a location of the RF device. One or more control processors direct the frequency search pattern based on a known, targeted response or in broad search for an unknown response or to capture responses from a range of potential targets.

Further, another embodiment of the present invention is related to a method for detecting the presence of a radio frequency (RF) device that includes: transmitting a radar signal, detecting harmonic signals generated by an RF device in response to an interaction of the radar signal with nonlinear characteristics of the RF device, processing the detected harmonic signals to provide an analysis result, and determining the presence of the RF device based on the analysis result

Moreover, another embodiment of the present invention is related to a method for determining a location of a radio frequency (RF) device that includes: transmitting a first radar signal and a second radar signal, the second radar signal being offset in frequency from the first radar signal, detecting intermodulation (IM) signals generated in response to an interaction of the first radar signal and the second radar signal with nonlinear characteristics of a RF device, analyzing the detected IM signals, and determining a location of the presence of the RF device based on the analyzing.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A and 1B are diagrams of example architectures for a target RF receiver;

FIGS. 2A and 2B are diagrams of antenna patterns for low gain and high gain antennas, respectively, according to an example embodiment of the present invention;

FIG. 3 is a diagram of a cross correlation technique according to an example embodiment of the present invention;

FIG. 4 is a diagram of an amplitude comparison monopulse technique according to an example embodiment of the present invention;

FIG. 5 is a block diagram of a radar system according to an example embodiment of the present invention;

FIG. 6 is a diagram of optimal filtering for several frequency pulse pairs according to an example embodiment of the present invention;

FIG. 7 is a diagram of the spectral response representative of the harmonic response of Equation 2 according to an example embodiment of the present invention;

FIG. 8 is a diagram of intermodulation nonlinear signatures according to an example embodiment of the present invention;

FIG. 9 is a flowchart of a process for processing pulse train return signals according to an example embodiment of the present invention; and

FIG. 10 is a flowchart of a process for radar detection of target RF devices according to an example embodiment of the present invention.

### DETAILED DESCRIPTION

The following detailed description of embodiments refers to the accompanying drawings, which illustrate specific embodiments of the invention. Other embodiments having different structures and operation do not depart from the scope of the present invention.

IEDs may be found using remote sensing techniques based on radar or electro-optical techniques when the employment is surface, covered or camouflaged, or buried. However, IEDs in an urban environment makes this application a difficult one.

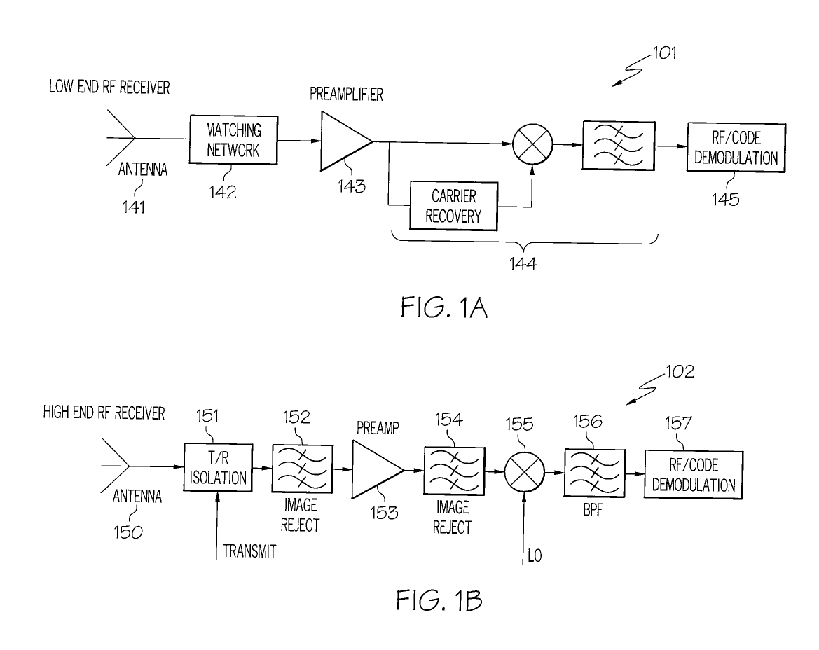

FIGS. 1A and 1B show diagrams of example architectures for a target RF receiver. FIG. 1 A shows an example architecture for a low-end RF device 101 and FIG. 1B shows an example architecture for a high-end RF device 102. In a low end (lower complexity) embodiment 101, an RF receiver RF portion generally consists of an antenna 141 (typically a low gain, narrowband, omni-directional device such as a monopole, dipole, or ferrite-core), an impedance matching/feed network stage 142, a preamplifier 143 (to boost the signal gain while adding as little noise as possible), followed by a down-conversion stage (carrier recovery, mixer, filter) 144 and signal demodulation components and logic 145.

In a high end (higher complexity) embodiment 102, an RF receiver RF portion may include an antenna (including matching network) 150, a transmit/receive isolation 151, a first image reject function 152, a preamp, 153, a second image reject function 154, a mixer 155 (down-conversion stage), a band pass filter 156, and RF signal demodulation components 157. An oscillator (not shown) sends a signal (LO) to the mixer 155.

While the block diagrams of FIGS. 1A and 1B indicate the direction of signal flow in the target RF receiver, there are bidirectional signals in the hardware due to impedance mismatches between components. When a transmitted radar signal interacts with impedance mismatch characteristics of these components in the target RF device 101, 102, an outgoing signal is radiated from the target RF device 101, 102. The outgoing signal is of a lower level, based on specific design implementations of the target RF device 101, 102, and will undergo gain and radiate out of a receive antenna of the target RF device 101, 102. The re-radiated signal will be indistinguishable from clutter returns in the vicinity of the RF system (clutter being all objects that scatter the radar signal in a linear manner with only an amplitude, phase-derived artifacts—related to the RF transfer function of the object—and possibly a Doppler shift if the scatterer is in motion), because of the anticipated low signal levels. However, any nonlinearities in the RF chain will result in clearly detectable changes between an appropriate transmitted radar signal and the signal that is re-radiated, i.e., these signals appear in a portion of the RF spectrum that is not occupied by the spectrum of the radar signal.

Embodiments according to the present invention may boost the discovery rate of RF triggered devices (e.g., IEDs) by detecting the presence of the RF link, without the need for the device to radiate or to be in operation (i.e., receiving a RF triggering command), beyond the effective blast radius of the improvised weapon. Additionally, systems and methods according to embodiments of the present invention may estimate the location of the RF device, based on the final implementation.

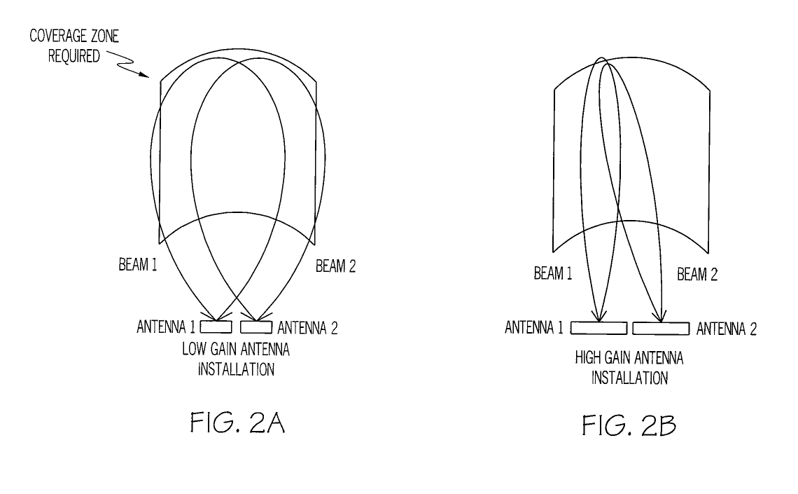

FIGS. 2A and 2B show diagrams of antenna patterns for low gain and high gain antennas, respectively, according to an example embodiment of the present invention. Embodiments of an RF system according to the present invention cover a region in front of the host vehicle of width and range extent to detect a device outside of the trigger or actuation region, thereby avoiding blast exposure. Both antennas may cover this region simultaneously, which means overlap of the antenna patterns as mapped onto this coverage region. The width of the individual antenna pattern may depend on the antenna size, itself a function of the required sensitivity and the “power” in the nonlinear observable, including any processing gain. As shown in FIG. 2A, if the antenna gain required is low, regardless of the operating frequency, then the patterns are broad and will give a wide angular coverage region without being scanned (physical beam scanning, either from an electronically scanned, fixed antenna or a mechanically pointed aperture, may not be necessary for nonlinear emitter angle estimation). As shown in FIG. 2B, if higher gain is required (larger apertures) such that the antenna pattern does not span the coverage region (beam width is approximately λ/D, where D is the antenna physical dimension) then scanning may be used to cover the surveillance region.

In embodiments according to the present invention with one receiver may produce a range-only solution (range being determined by the time delay between radar signal radiation and nonlinear response reception, referenced to an internal clock in the radar system), embodiments with two receivers may give a range and one angle, while embodiments with three receivers may produce a range and two angles. For illustration purposes, embodiments of the present invention will be described with two receivers. However, embodiments of the present invention are not limited to two receivers but may include any number of receivers. As noted above, increasing the number of receivers increases localization capabilities. Knowledge of the location of an RF device such as an TED allows avoidance or engagement, depending on the tactical situation.

The two antenna approach eliminates any spectral artifacts in the transmitted waveform resulting from nonlinearities in the transmitting system hardware resulting from the two signals interacting within the same RF channel. This prevents the introduction of artifacts by the transmitting hardware that are the same (or similar) to the target signal when two equal amplitude, (potentially) high power, signals are combined in a single transmitting system. Such artifacts may be transmitted and scattered off the environment and either desensitize the system, introduce false detections, or both. The additional hardware may be easier to implement, and hence ultimately cheaper, than a single system with sufficient linearity. Thus, the two antenna case generally may represent the lower risk. Although, the nonlinear effect may be understood, the magnitude of the radiated signal may not be known. Thus how much radiated power, antenna gain and processing gain is required, and over what dynamic range representing the class of targets—nonlinear junctions—to effect reliable detection at standoff positions, may not be well defined. Therefore, according to embodiments of the present invention, two or more antennas provide the means to estimate angular position of an emitter by any one of several different techniques. The technique used may be a function of the final antenna configuration. For example, techniques used may be two-channel cross correlation (time-based), amplitude comparison monopulse (real or complex), phase comparison monopulse (complex), etc. Other techniques may also be used given a higher degree of system complexity such as implementing an array antenna on the receiver.

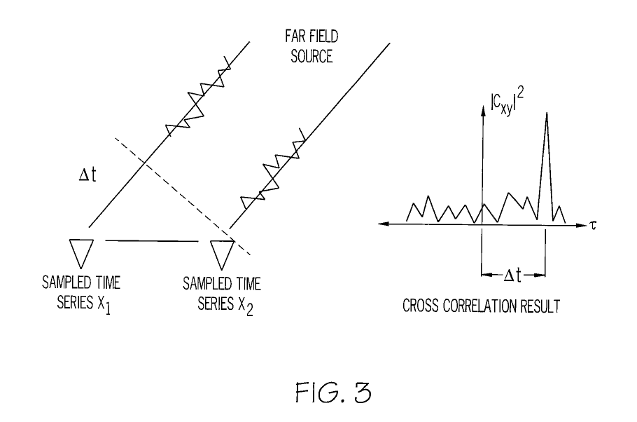

FIG. 3 shows a diagram of a cross correlation technique according to an example embodiment of the present invention. The cross correlation technique measures the difference in arrival time of a signal at two points in space. The cross correlation operation can be either analog or digital. In this example embodiment, the assumption is that the two channels are sampled by an analog-to-digital converter (ADC), driven by a common clock and with appropriate calibration, and successive, overlapping blocks of data are correlated one against the other. With similar channel responses, the peak correlation occurs at the time difference of arrival of the signal in the two channels. The cross correlation operation may be written as:

$${C}_{xy} = {\sum }_{i = - N / 2}^{N / 2} X ( t ) \cdot Y ( t - i ) \qquad [ 1 ]$$

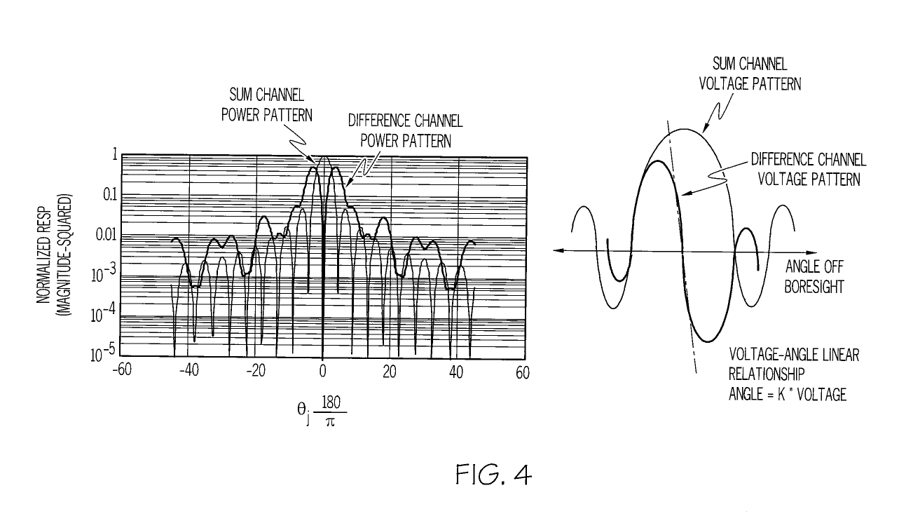

FIG. 4 shows a diagram of an amplitude comparison monopulse technique according to an example embodiment of the present invention. The amplitude comparison monopulse technique makes an amplitude comparison in two channels sample an antenna pattern where the individual

beams (from each channel) are strongly overlapped (as shown in FIG. 2A previously). The signals in each channel may be subtracted producing a difference pattern. The slope of the difference pattern is related to the element separation. Thus, the voltage from the target response in the difference channel may be (ideally) linearly related to the angle of the target off the line that represents the antenna boresight.

The phase comparison monopulse method embodiment may be employed when the antennas are separated by an amount that is large compared to the antenna size. The phase in each antenna channel is determined and the difference in phase between the two channels is proportional to the angle of arrival relative to the normal of the antenna bisector. Performance may be related to the carrier frequency of the radar signal. If the path length difference to the two antenna channels is greater than the wavelength then the angle estimation may be ambiguous and should be resolved. Angle estimation in two dimensions may require instrumentation in each cardinal direction (azimuth and elevation). This may be accomplished by two antenna elements for a single dimension and four antenna elements for both. The system user may want to locate the source of the nonlinear returns to either avoid or to defeat it. Any type of angle estimation is within the scope of the present invention, even though the type selected may be the result of system tradeoffs given the overall system design and sizing and may draw from existing techniques.

Radar system embodiments according to the present invention for detecting non-linear RF devices may consist of a pair (or more) of transmitting antennas and the associated transmit and receive electronics. The radar provides detection of the presence of RF and antenna systems based on processed responses (discussed below) that are the result of the illumination and reception by the non-linear transmitted signals. Radar system embodiments may be installed or mounted on any type of apparatus and still be within the scope of the present invention. For example, radar system embodiments may be installed on a stationary platform, or installed on a moving apparatus such as, for example, a motor vehicle, a tank, an aircraft or rotorcraft, a ship, a Humvee, etc.

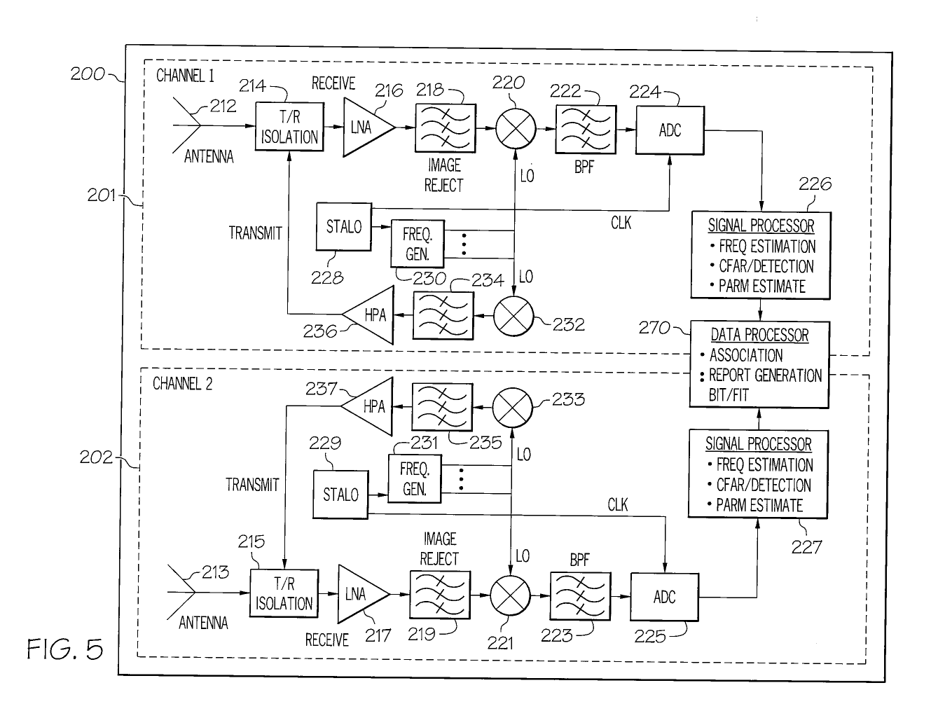

FIG. 5 shows a block diagram of a radar system according to an example embodiment of the present invention. The radar system 200 may include two or more channels. In this example embodiment, two channels 201, 202 are shown. Each channel 201, 202 may include at least one antenna 212, 213 that is interconnected to a corresponding transmit/receive isolator 214, 215. The means of providing the isolation of the receiver from the high power signals that emanate from the transmitter may be provided in any of many various ways. As with the angle estimation method above, the ultimate selection may be the result of detailed trades against the nonlinear phenomenology. In particular the ultimate bandwidth requirements on the system and the operating power level may exert large influences. In an embodiment, a microwave isolator (a nonreciprocal, 3 port ferrite device) may be used. The circulator maintains a continuous RF circuit but shunts spurious transmitter emissions into a matched load when the receiver is switched in. In another embodiment, a microwave switch or other high power handling, rapid switching time device may be used. In addition, in a still further embodiment, a method may be used to feed forward the transmitted signal into the receiver and subtract it with the appropriate amount of delay. This has been used in monostatic and bistatic systems.

The transmit/receive isolators 214, 215 may each be interconnected to a corresponding low noise amplifier (LNA) 216, 217, which provides an output to an image reject bandpass filter 218, 219. The image reject filters 218, 219 bandlimit contributions from outer band energy. The image reject filter 218, 219 provides output to a mixer 220, 221 that feeds a bandpass filter (BPF) 222, 223. The BPF 222, 223 provides an output to an analog-to-digital (ADC) converter 224, 225 that provides output to a signal processor 226, 227 for further analysis/processing. The signal processor 226, 227 may perform various functions such as, for example, frequency estimation, constant fault alarm rate (CFAR)/detection, parameter estimation, etc. The signal processors may then output to a data processor 270 for further analysis/processing. The data processor 270 may perform various functions such as for example, signal association processing, report generation, built-in-testing/fault isolation testing (BIT/FIT), timing and synchronization, etc. Moreover, according to embodiments of the present invention a single processor may perform the functions of both the signal processor and the data processor. A control processor, which may be embedded in the data processor function, serves to sequence the frequency search pattern of the radiated signals in response to operator directives. Such directives might be to use patterns to target a particular device type with known response. It might also be to conduct a broad search when no a priori knowledge is available

Each channel 201, 202 may also include a stable local oscillator (STALO) 228, 229 that sends signals to the ADC 224, 225 and a waveform generator (freq. gen.) 230, 231. The waveform generation device (freq. gen.) 230, 231 provides an output to the mixers 220, 221, and to an associated up converter 232, 233. The up-conversion function 232, 233 provides an output to filters 234, 235 that may feed a high power amplifier (HPA) 236, 237 that outputs to the at least one antenna 212, 213 through the transmit/receive isolation function 214, 215. A common master clock or timing reference (not shown) feeds into each stable local oscillator (STALO) 228, 229 and provides highly accurate timing signals for system control, sequencing of radiated signals and synchronization of all functions and processing

For any (ω₁, ω₂) transmit pair there is a discrete set of frequencies than can be returned from a nonlinear junction, based on one of several potential response modes of the target device. One such mode is the small signal/amplifier model. Any one of the combinations 2ω₁-ω₂, 2ω₂-ω₁, etc. might be present. The bandwidth of these spectral lines may be equal to the bandwidth of either channel (required to be the same here). Since ranging of the object with some reasonable accuracy and operation at short ranges is desirable, a fairly short pulse may be used. This also serves to produce a useful maximum blanking range—where the T/R isolator has inhibited receiver operation. For example, assume that a 25 MHz pulse bandwidth is used. For an envelope modulated carrier this translates into a range resolution of ˜6 m and nominal range estimation accuracy on the order of 0.6 m. The pulse duration is 0.04 μsec (40 nsec) which means that a nominal maximum blanking range might be 18 m (3 sample gates blanked).

Assume an RF system operating, tunable frequency range from 500 MHz to 1.5 GHz. Set channel 1 to the midband frequency and step the other over the tunable range using a 25 MHz signal bandwidth (39 frequency steps as ω₁=ω₂ is not relevant). With a maximum range of 250 m (almost 100 dB of R⁴) the pulse repetition frequency (PRF) may be set at 500 kHz. A 1000 pulse coherent dwell then means that the full spectral range may be covered in 1.7 msec. At 6 m resolution and assuming a vehicle speed of 20 m/sec, the vehicle only translates 30 cm in a CPI (coherent processing interval) and, as such, platform motion can be largely ignored in the filtering process. Preferentially it may be desired to filter around the candidate receive frequencies over a bandwidth that will minimize the contributions of signals that are spurious in the RF environment. This may help with the overall SINR (signal-to-interference-plus noise ratio).

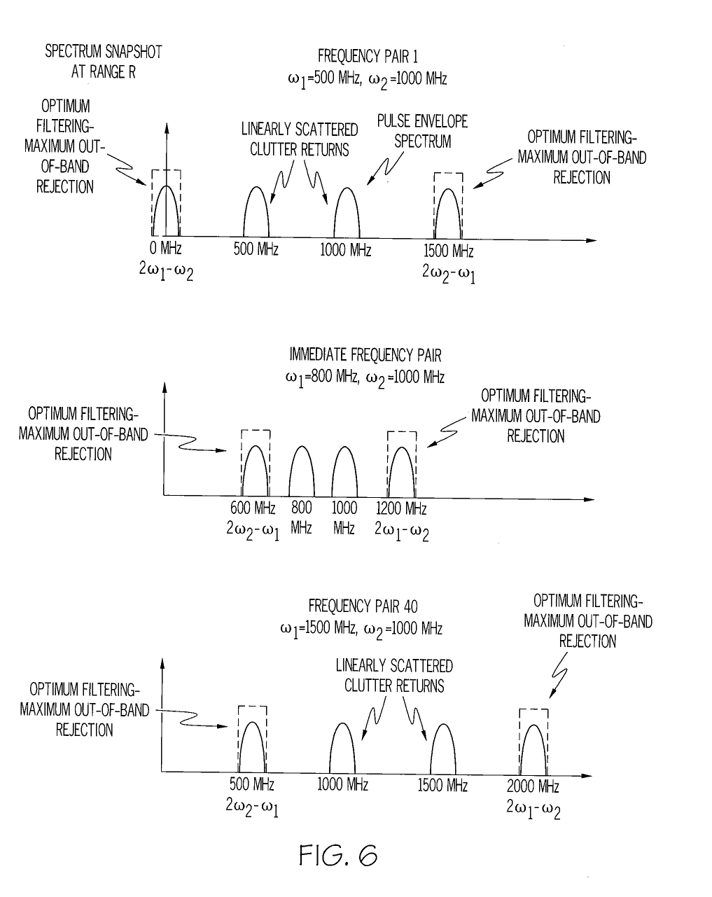

FIG. 6 shows a diagram of optimal filtering for several frequency pulse pairs according to an example embodiment of the present invention with the small signal/amplifier model. Shown in the figure are optimal filtering for several frequency pulse pairs (representing the first, an intermediate, and the last), based on the assumption of no pulse envelope modulation by the nonlinear process. Out-of-band may be represented by all frequencies outside of the dashed boxes surrounding the 2ω₁-ω₂, 2ω₂-ω₁ “lines”. The location of the passbands may be a function of the pulse pair. There may be implementation/complexity issues on such an approach, particularly if there is an attempt to realize a switchable bank of analog filters of this “two tooth comb” type. A digital implementation, where the coefficients are loaded based on the waveform, may be more tractable. A two receiver approach per antenna channel may be used where each receiver is tuned to a single passband and results combined in at the detector stage. According to embodiments of the present invention, a channelized receiver may also be used where a series of parallel filters are implemented and only those channels selected that match any or all nonlinear signal model responses that are being sought. In some embodiments according to the present invention, frequencies that may have a lot of interference or which may create problems of interoperability for other systems (like GPS) may be avoided (i.e., not transmitted).

In the example system shown in FIG. 6, the transmit chain may consist of a digital RF memory from which the pulse waveforms are selected. The waveform may be clocked using a very stable local oscillator that provides an acceptable phase noise spectrum (level of phase noise and/or clock jitter with no spurs that might introduce artifacts in the radiated signal that would then appear as returns from a nonlinear junction) through a digital to analog converter (DAC) and filtered to produce the analog pulse signal. The signal may be created at a convenient intermediate frequency (IF) and be translated to the carrier frequency for transmission. Single stage or double stage balanced mixers (or the equivalent) may be used, with appropriate filtering of the output nonlinear terms, to produce a signal at the desired radio frequency. This signal is ready for high power amplification, the final stage before radiation through the antenna. Depending on the spectral quality of the HPA (high power amplifier, solid state, tube or hybrid), filtering of the output may be necessary as a consequence of system design tradeoffs, cost, etc. Further, the input signal may be pre-emphasized in a manner that the amplifier undesirable artifacts are cancelled. This may be based on repeated, periodic calibration measurements made during operation. Free space separation of the two transmit channels may inhibit interactions of the two signals after radiation, except in the targets surveillance region/zone, thus preventing the creation of potentially masking or densitizing (to the radar receivers) returns.

According to embodiments of the present invention, two narrowband, rectangular envelope modulated constant carrier, ultra-low phase noise linear signal pulses (individual pulses and/or coherent pulse trains) that are offset in frequency (and tunable in a programmable sequence that spans a designed frequency range, possibly ultra-wideband, to perform a frequency-based search for RF devices) are radiated, one from each of the two channels 201, 202, by the radar system 200. All references to the radiated linear signal pulse include this frequency tunability.

Although embodiments according to the present invention may be in the form of any of several system topologies, in this example embodiment each transmitter 212, 213 radiates a single frequency and each receives the full bandwidth for subsequent analysis/processing. The radar system 200 may be a monostatic radar. As noted previously, the monostatic radar includes the stable local oscillator 228, 229 that provides a master frequency and clock reference, the waveform generation 230, 231, the up-conversion 232, 233 and filtering 234, 235, and isolation/duplexing 214, 215 to permit receive-transmit operation using a single antenna 212, 213. On the receive side, the monostatic radar may include the output from each antenna 212, 213 undergoing low noise amplification 216, 217, down-conversion 220, 221 (to a convenient intermediate frequency (IF) that could be an ultrawide baseband, depending on the analog-to-digital converter 224, 225 sample rate) and filtering 218, 219.

Embodiments according to the present invention may be bi-static in that the system may employ antennas for transmit and receive that are not the same, and that are physically separated. For example, a Channel 1 may radiate f1 and receive all products from antenna 1 and antenna 2 modulated by the target or simply reflected by the environment. Likewise a Channel 2 may radiate f2 and receive all returns. However this may be more rigorously co-located bistatic and may be a consequence of the implementation, not of any special feature that can be ascribed to bistatic operation in general. The bistatic angle between transmitter and receiver is in the pseudo-monostatic regime, even over the short ranges envisioned for operation.

Pulsed operation of the transmitted signals from the radar system 200 is preferable (although not essential) to permit ranging via estimation of the two-way time delay to the nonlinear response source (i.e., target RF device 101, 102). Pulse lengths preferably are matched to system sensitivity (detection range) in order to avoid eclipsing (i.e., blocking of the return signal by the duplexer/isolator 214, 215). Extremely low phase noise on the transmitted signals is also preferable so that products of the transmit signal spectral sidebands are well below system noise and the spectral artifacts produced by the RF target nonlinear response. Failure to meet this constraint would result in unacceptable levels of false alarms.

Radar embodiments of the present invention exploit the nonlinear response of RF components, regardless of whether the RF component is an active device (e.g., an amplifier) or a passive device (e.g., waveguides or diodes). All target devices will evidence nonlinearities if the incident field strength/voltage levels are sufficiently high. In embodiments according to the present invention, the nonlinear responses from active devices like amplifiers, filters and mixers, or are diode-like may be explicitly identified. There are artifacts in RF components, a consequence of materials properties changes over time, breakdown or dirt that may introduce nonlinear responses (the “tin whisker” in the waveguide effect). These occur regardless of the power state. There may be changes in the responses as a function of the power state of the device.

There are two phenomena that are exploited by the transmitted radar probing signals transmitted by the radar system 200: first, the generation of harmonics when either or both of the probing signals interact with any nonlinear characteristics of the target RF devices 101, 102 such as those shown previously in FIGS. 1A and 1B (frequencies that are not present in the spectrum of the transmitted waveforms) and, secondly, the generation of intermodulation (IM) products, harmonic products, or both when both of the probing signals interact with any nonlinear characteristics of the target RF devices 101, 102. IM products and harmonics have a strict mathematical relationship to the probing signal(s). In the case of the latter the products are integer multiples. This will be further discussed following.

The target RF device 101, 102 may be represented as a memory-less, linear, time variant system with the general input-output relationship as given in Equation 2.

y(t)≈α₁x(t)+α₂x²(t)+α₃x³(t)+ [2]

The harmonics produced when radar system 200 probing signal x(t)=A cos(ωt) interacts with the target nonlinear RF device are given in Equation 3 as

$$y ( t ) = \frac{{α}_{2} {A}^{2}}{2} + ( {α}_{1} A + \frac{3 {α}_{3} {A}^{3}}{4} ) cos ( ω t ) + \frac{{α}_{2} {A}^{2}}{2} cos ( 2 ω t ) + \frac{3 {α}_{3} {A}^{3}}{4} cos ( 3 ω t ) \qquad [ 3 ]$$

where the harmonic terms are given by the 2ω and 3ω (and possibly higher) order terms.

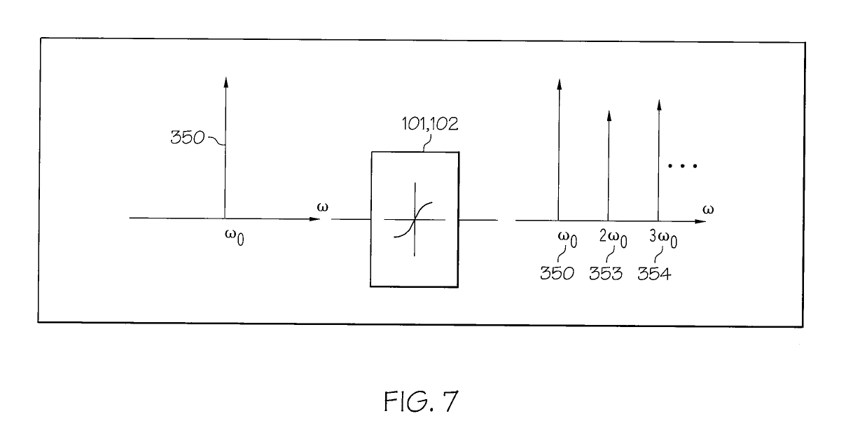

FIG. 7 shows a diagram of the spectral response representative of the harmonic response of Equation 3 according to an example embodiment of the present invention. This is termed the “diode-like” response. A probing linear signal 350 is transmitted from a radar system 200. When the signal 350 interacts with any nonlinear characteristics of a target RF device 101, 102, harmonics 353, 354 of the transmitted signal 350 are generated. The receipt of these harmonics by the radar system 200 provides detection of the target RF device 101, 102. With two radar signals probing the target the response could include integer multiples of both. Further sum and difference terms from this interaction may result (f1−f2, f1+f2, 2f1−2f2, etc.). Lastly, either or both probing signals might interact with the local oscillator in the target device, again producing a unique intermodulation pattern at the radar receiver.

One example of the intermodulation (IM) spectrum is based on the small signal model for amplifiers. For an input signal of the form

x(t)=A₁ cos(ω₁t)+A₂ cos(ω₂t) [4]

where A₁ and A₂ are the amplitudes of the incident signal components, assuming a response in the form of Equation 1, then the response to Equation 4 is a series of spectral components comprised of the fundamental components (relating to ω1 and ω2) and a series of new components that were present in the input signal. The fundamental components shown in Equations 5-8 are given by:

ω=ω₁, ω₂: (α₁A₁+¾α₃A₁³+ 3/2α₃A₁A₂²)cos (ω₁t)+(α₁A₂+¾α₃A₂³+ 3/2α₃A₂A₁²)cos(ω₂t) [5]

ω=ω₁±ω₂: α₂A₁A₂ cos (ω₁+ω2)t+α₂A₁A₂ cos(ω₁−ω₂)t [6]

ω=2ω₁±ω₂: ¾α₃A₁²A₂ cos(2ω₁+ω₂)t+¾α₃A₁²A₂ cos(2ω₁−ω₂)t [7]

ω=2ω₂±ω₁: ¾α₃A₂²A₁ cos(2ω₂+ω₁)t+¾α₃A₂²A₁ cos(2ω₂−ω₁)t [8]

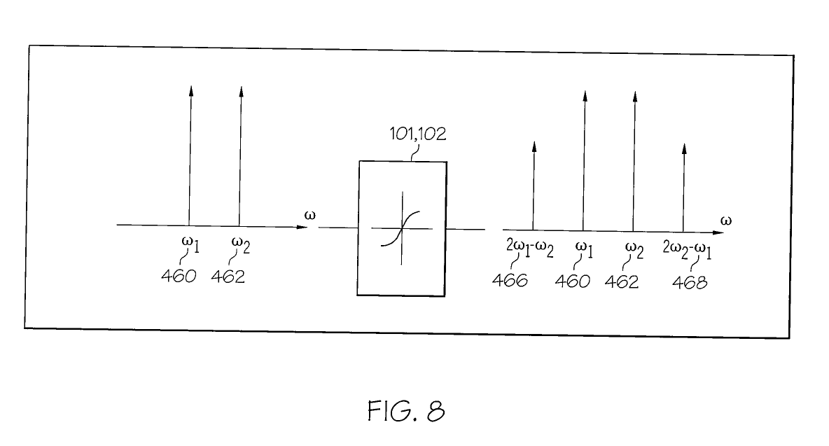

FIG. 8 shows a diagram of intermodulation nonlinear signatures according to an example embodiment of the present invention. A radar system 200 generates and transmits two linear signals 460, 462 where the two signals may be pulses that are offset in frequency and tunable. When the two transmitted signals 460, 462 interact with any nonlinear characteristics of a target RF device 101, 102, a series of spectral components are generated that include the fundamental component two signals 460, 462 and a series of new components 466, 468 related to the two transmitted signals 460, 462. The receipt of these new components by the radar system 200 permits ranging via estimation of the two-way time delay to the target RF device 101, 102.

As noted previously, the radiated outgoing signal from the target RF device 101, 102 is of a lower level, based on specific design implementations of the target receiver, and will undergo gain and radiate out of the receive antenna. According to embodiments of the present invention, the sensitivity of the radar system 200 may be established by this outgoing signal level, the range from the target RF device 101, 102 to the radar system, and the radar system 200 receiver noise level that includes any processing gain in the radar system 200, including coherent processing gain from the coherent addition of multiple returns at the same transmit frequency settings before proceeding to the next frequency step.

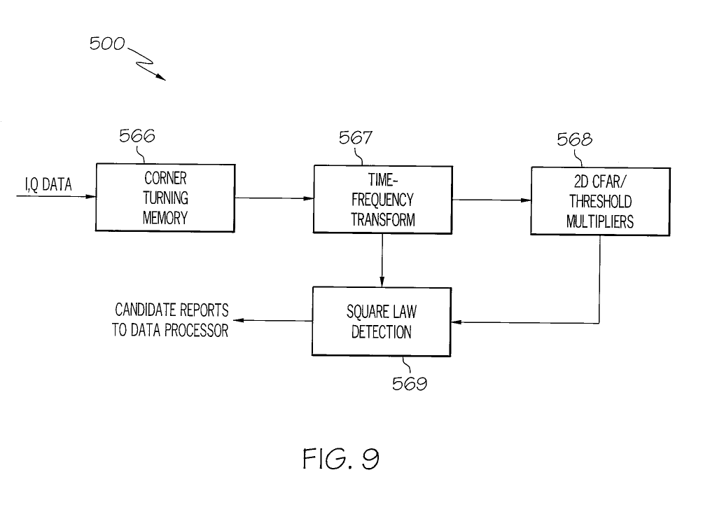

FIG. 9 shows a flowchart of a process in a signal processor for processing target RF device return signals according to an example embodiment of the present invention. The process 500 may be embodied in each of the signal processors 226, 227 and/or the data processor 270 of the radar system 200. The return signals (I,Q data) may be received by a corner turning memory 566 that reads fast time and outputs by slow time. The corner turning memory 566 may provide an output to a time-frequency transform 567 that performs spectral estimation, and that may include coherent slow-time analysis/processing, which in turn provides outputs to at least one 2D CFAR interference level estimator that includes threshold multiplier 568. The at least one 2D CFAR threshold multiplier 568 may send output to a square law detection function 569 that determines target detection/absence (e.g., via a Neyman-Pearson or similar hypothesis test) and outputs candidate reports. The candidate reports may be fed to a data processor 270 for further analysis/processing.

According to embodiments of the present invention, detection of either the harmonic or IM processes occur in the frequency domain, after range gating of the target RF device 101, 102 pulse train return. Several algorithms are available to analyze/process the sampled time domain return, detect the presence on signals different than the probing signals, as well as estimate the frequency of the return signals. These include, for example, simple FFT processing or any one of a number of adaptive processes (e.g., MUltiple SIgnal Characterization (MUSIC), pencil MUSIC, etc.). The probing linear signals radiated by the radar system 200 are extremely linear and phase stable so that the nonlinear responses from a target RF device 101, 102 may be more accurately received.

Once detection has occurred in both receiver channels of the radar system, the results are correlated to estimate the direction of arrival of the nonlinear responses. This can be done in any of several ways. For example, the most straight forward method may be a two-channel interferometer. The latency in issuing detections may be on the order of three detection epochs, an epoch being the data sampling interval equivalent to coherent processing and signal spectral estimation. For example, if the signal integration period were 100 msec, then three detection intervals, including the possibility of multiple observations to confirm the presence of a return, before issuing a decision/warning, would be approximately 300 msec (˜3 Hz).

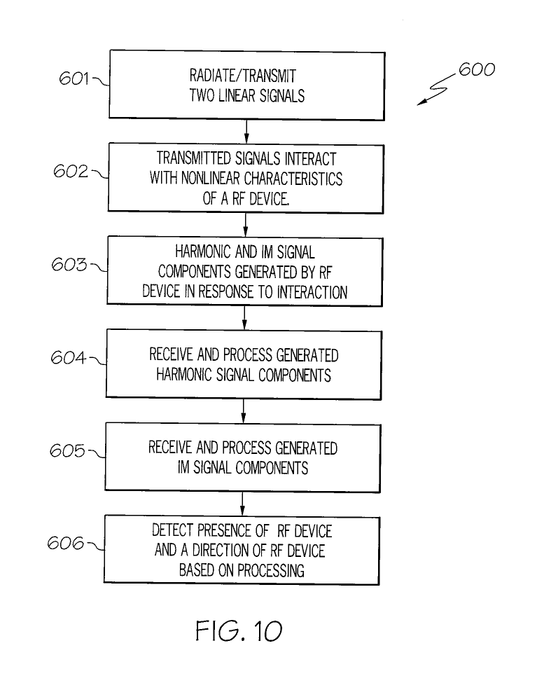

FIG. 10 shows a flowchart of a process for radar detection of target RF devices according to an example embodiment of the present invention. The process 600 may be embodied in the radar system 200 shown in FIG. 2. In block 601, at least two linear signals are radiated or transmitted. Preferably, the two signals are pulses that are offset in frequency and are tunable. In block 602 the two transmitted signals interact with nonlinear characteristics of a target RF device 101, 102. In block 603, in response to the interaction, harmonic and intermodulation signal components are generated by the RF device that include the fundamental transmitted two signals and a series of new signal components related to the transmitted two signals. In block 604, the generated harmonic signal components are received and processed. In block 605, the generated IM signal components are received and processed. The analysis/processing may include range gating of the received signal components and using processing algorithms. In block 606, the presence of the RF device is detected and a direction of the RF device is determined based on the analysis/processing.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A system for detection and location of a radio frequency (RF) device, comprising:
a first channel comprising a first antenna and a first processor, the first channel capable of transmitting a first radar signal and receiving RF signals; and
a second channel comprising a second antenna and a second processor, the second channel capable of transmitting a second radar signal and receiving RF signals, the second radar signal being offset in frequency from the first radar signal, wherein the first processor and the second processor are each is configured to analyze at least one of harmonic signals and intermodal (IM) signals generated by the RF device in response to the first radar signal and the second radar signal to provide detection of the RF device and an estimated location of the RF device.

2. The system according to claim 1, wherein the RF device is detected independent of whether the RF device is an active RF device or a passive RF device.

3. The system according to claim 1, wherein the first radar signal and the second radar signal are linear radar signals.

4. The system according to claim 1, wherein the first radar signal and the second radar signal comprise pulsed signals.

5. (canceled)

6. The system according to claim 1, wherein the RF device comprises an Improvised Explosive Device (IED).

7. The system according to claim 1, wherein the harmonic and IM signals comprise nonlinear responses of RF components in the RF device generated in response to the first radar signal and the second radar signal interacting with one or more nonlinear characteristics of the RF device.

8. The system according to claim 1, further comprising the use of a Fast Fourier Transform (FFT) to analyze the harmonic signals.

9. The system according to claim 1, further comprising a two-channel interferometer to analyze the IM signals.

10. The system according to claim 1, wherein a sensitivity of the first radar signal and the second radar signal is established using a signal level of a signal radiated from the RF device based on bidirectional signals due to impedance mismatches between components in the RF device, a range from the radar system to the RF device, and a radar system receiver noise level.

11. The system according to claim 1,
wherein each of the first channel and the second channel further comprise:
a transmit/receive isolation device operatively connected to one of the first antenna or the second antenna;
a low noise amplifier (LNA) operatively connected to the transmit/receive isolation device;
an image reject filter operatively connected to the LNA;
a down conversion function operatively connected to the image reject filter;
a bandpass filter operatively connected to the down conversion function;
an analog-to-digital converter (ADC) operatively connected to the bandpass filter and providing output to one of the the first processor and the second processor;
a stable local oscillator;
a waveform generator operatively connected to the local oscillator;
an up conversion function operatively connected to the waveform generator;
a filter operatively connected to the waveform generator; and
a high power amplifier (HPA) operatively connected to the filter and providing output to one of the first antenna and the second antenna.

12. A method for detecting the presence of a radio frequency (RF) device, comprising:
transmitting a radar signal by a radar system;
detecting harmonic signals generated by an RF device in response to an interaction of the radar signal with nonlinear characteristics of the RF device, the harmonic signals being detected by a first channel and a second channel of the radar system;
detecting intermodulation (IM) signals generated by the RF device by the first channel and the second channel of the radar system, in response to the radar signal;
processing the detected harmonic signals in at least one of a first processor of the first channel and a second processor of the second channel of the radar system;
processing the detected IM signals in at least one of the first processor of the first channel and the second processor of the second channel of the radar system, wherein the IM signals and the harmonic signals are processed to provide an analysis result; and
determining the presence of the RF device based on the analysis result.

13. The method according to claim 12, wherein the radar signal is a linear radar signal.

14. The method according to claim 12, further comprising detecting a range of the RF device including the operations of
transmitting a pulsed radar signal to the device; and
analyzing a delay associated with the detected harmonic signal based on the pulsed radar signal.

15. The method according to claim 12, wherein the processing comprises using at least one of a Fast Fourier Transform (FFT) processing of the harmonic signals or MUltiple SIgnal Characterization (MUSIC) adaptive processing of the harmonic signals.

16. The method according to claim 12, further comprising detecting nonlinear responses of RF components in the RF device.

17. The method according to claim 12, wherein detecting the RF device comprises detecting an Improvised Explosive Device (IED).

18. The method according to claim 12, further comprising adjusting a sensitivity of the radar system transmitting the radar signal based on a signal level of a signal radiated from the RF device based on bidirectional signals due to impedance mismatches between components in the RF device, a range from a source of the transmitted linear radar signal to the RF device, and a noise level of a receiver receiving the harmonic signals.

19. A method for determining a location of a radio frequency (RF) device comprising:
transmitting a first radar signal by a first channel of a radar system and a second radar signal by a second channel of the radar system, the second radar signal being offset in frequency from the first radar signal;
detecting harmonic signals generated in response to an interaction of the first radar signal and the second radar signal with the RF device, the harmonic signals being detected by at least one of the first channel of the radar system and the second channel of the radar system;
detecting intermodulation (IM) signals generated in response to the interaction of the first radar signal and the second radar signal with nonlinear characteristics of the RF device, the IM signals being detected by at least one of the first channel and the second channel of the radar system;
analyzing the detected harmonic signals by at least one of a first processor of the first channel and a second processor of the second channel of the radar system;
analyzing the detected IM signals by at least one of the first processor of the first channel and the second processor of the second channel of the radar system; and
determining a location of the presence of the RF device based on the analyzing of at least the IM signals.

20. The method according to claim 19, further comprising transmitting a first linear radar signal and a second linear radar signal.

21. The method according to claim 19, further comprising transmitting a pulsed first radar signal and a pulsed second radar signal.

22. The method according to claim 19, wherein the analyzing comprises using a 2 channel interferometer.

23. The method according to claim 19, further comprising detecting nonlinear responses of RF components in the RF device.

24. The method according to claim 19, wherein determining a location of the presence of the RF device comprises locating an Improvised Explosive Device (IED).

25. The method according to claim 19, further comprising adjusting a sensitivity of the radar system transmitting the first radar signal and the second radar signal based on a signal level of a signal radiated from the RF device based on bidirectional signals due to impedance mismatches between components in the RF device, a range from a source of the transmitted radar signals to the RF device, and a noise level of a receiver receiving the harmonic signals.
